(19) United States
(12) Patent Application Publication
(10) Pub. No.: US 2006/0065317 A1
(43) Pub. Date: Mar. 30, 2006

(54) Modular manifold system for fluid distribution and method of making the same

(76) Inventors: Larry B. Higgins, Gaylord, MI (US); Gary Lee Knirk, Petoskey, MI (US); Scott S. Sheppard, Brutus, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/233,932

(22) Filed: Sep. 23, 2005

Related U.S. Application Data
(60) Provisional application No. 60/613,159, filed on Sep. 24, 2004.

(51) Int. Cl. F17D 1/00

(52) U.S. Cl. 137/884

(57) ABSTRACT

A modular manifold assembly includes at least one barbed distribution connector disposed on a modular manifold body. Individual modular manifold assemblies are assembled into various lengths as required to accommodate multiple different desired fluid distribution system configurations. The modular manifold body employs a tubular design with a D-shaped cross-section that allows ease of assembly. The at least one barbed distribution connector attaches to at least one distribution line to distribute fluid throughout a fluid distribution system.

The application claims priority to U.S. Provisional Application No. 60/613,159, which was filed on Sep. 24, 2004.

### BACKGROUND OF THE INVENTION

The present invention is directed to a modular manifold assembly for a fluid distribution system and a method of economically manufacturing a desired fluid distribution system including the modular manifold assembly.

Known fluid distribution systems are constructed from standard manifolds. Known standard manifolds are typically made from copper and are manufactured in various standard lengths. To accommodate a variety of desired fluid distribution system configurations including, for example, hydronic heating systems and/or potable water systems, the various standard lengths are cut to size and assembled as required to achieve the desired fluid distribution system configuration. This process requires a significant amount of additional time and labor. In addition, fluid distribution system component wholesalers must carry a large inventory of each of the many different standard length manifolds and branch connectors in order to accommodate the variety of desired fluid distribution system configurations.

As such, it would be desirable to provide a modular manifold assembly for a fluid distribution system, which is flexible, requires less labor to assemble, is less expensive to construct, and eliminates the need to stock multiple individual standard length manifolds in inventory.

### SUMMARY OF THE INVENTION

A modular manifold assembly of the present invention includes at least one distribution connector attached to a modular manifold body. Individual modular manifold assemblies are assembled into various lengths as required to accommodate multiple different desired fluid distribution system configurations. The modular manifold body employs a tubular design with a D-shaped cross-section that allows ease of assembly. The at least one distribution connector attaches to at least one distribution line to distribute fluid throughout a fluid distribution system.

A desired fluid distribution system is manufactured by assembling modular manifold assemblies together with standard branch connectors to form the desired fluid system configuration. Each D-shaped end of the modular manifold body is flared to form a circular opening which facilitates joining multiple modular manifold assemblies, standard branch connectors or a termination and allows each individual modular manifold assembly to rotate in any direction.

These and other features of the present invention can be best understood from the following specification and drawings, the following of which is a brief description.

### BRIEF DESCRIPTION OF THE DRAWINGS

FIG. 1 schematically illustrates an example fluid distribution system;

FIG. 2 illustrates example floor geometries;

FIG. 3 illustrates a modular manifold assembly according to one embodiment of the present invention;

FIG. 4 illustrates an example fluid distribution system according to one embodiment of the present invention;

FIG. 5 illustrates a cross-section of one embodiment of a modular manifold assembly of the present invention through a Section A-A shown in FIG. 3; and

FIG. 6 illustrates a cross-section of one embodiment of a modular manifold assembly of the present invention through a Section B-B shown in FIG. 3.

### DETAILED DESCRIPTION OF THE PREFERRED EMBODIMENT

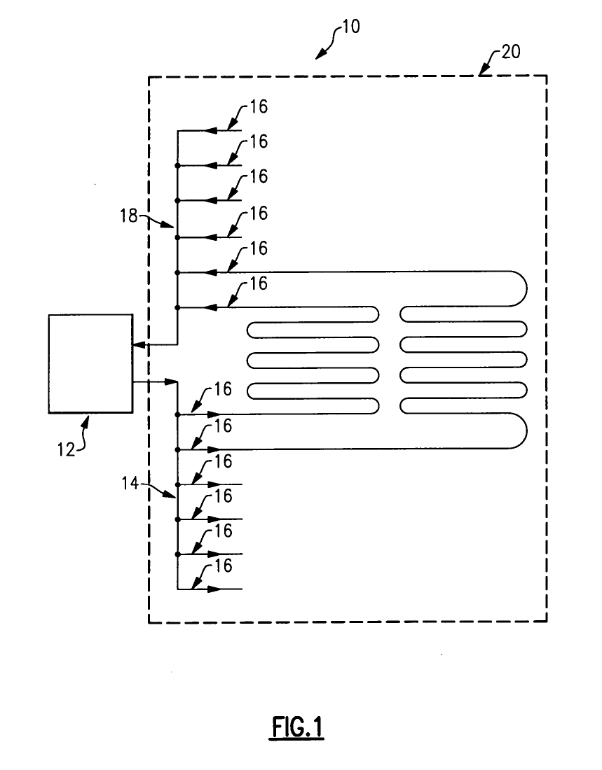

FIG. 1 schematically illustrates an example fluid distribution system 10. A main fluid distribution system 12 distributes a fluid, for example, water, to a main supply manifold 14 including a plurality of distribution tubes 16 extending from the main supply manifold 14 to a main return manifold 18. The fluid is distributed from the main fluid distribution system 12 to the main supply manifold 14. The main supply manifold 14 distributes the fluid to each of the plurality of distribution tubes 16. The fluid circulates through each of the plurality of distribution tubes 16 to the main return manifold 18. The fluid from the plurality of distribution tubes 16 is consolidated within the main return manifold 18 and returned to the main fluid distribution system 12.

The main fluid distribution system 12, for example, may include provisions to heat the fluid and provide heated fluid through the fluid distribution system 10 to warm a floor 20. The number of distribution tubes 16 required and the configuration of the distribution tubes 16 is determined by the shape and size of a desired surface area of the floor 20 to be heated.

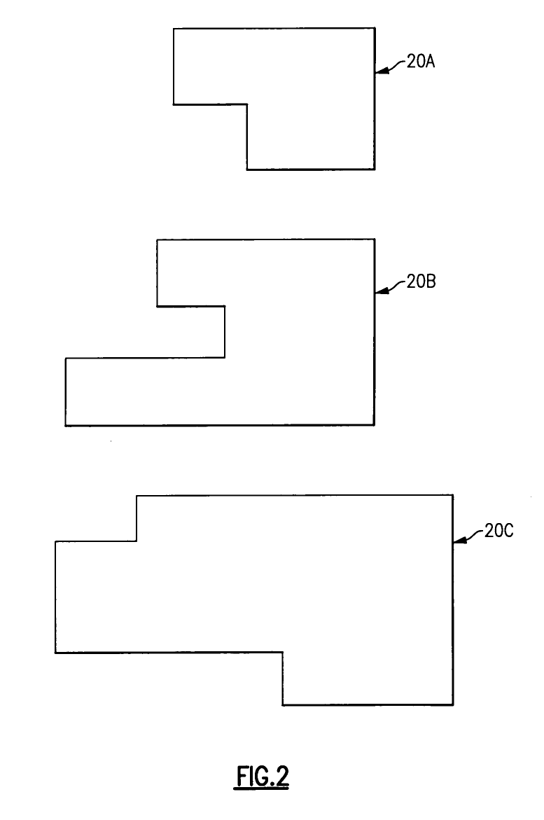

In the illustrated example, there are six distribution tubes 16 that require connection to both the main supply manifold 14 and the main return manifold 18. The illustrated floor 20 has a rectangular shape that requires the main supply manifold 14 and the one main return manifold 18 to include six distribution connectors (not shown) each for connection to each of the six distribution tubes 16. However, more complex floor shapes 20 A-C, examples of which are illustrated as FIG. 2, require longer main supply manifolds 14, longer main return manifolds 18 and additional distribution tubes 16 to direct the fluid flow to accommodate the various floor geometries.

FIG. 3 shows an example modular manifold assembly 30 of the present invention. The modular manifold assembly 30 includes a male end 32, a female end 34 and a body 36 disposed between the male end 32 and the female end 34. The body 36 includes a D-shaped cross-section as shown in FIG. 5. Three distribution connections 38 or barbed ends are disposed along a length of the body 36. A fluid flows through the body 36 and is distributed to the distribution connections 38 for further distribution to distribution tubes (not shown).

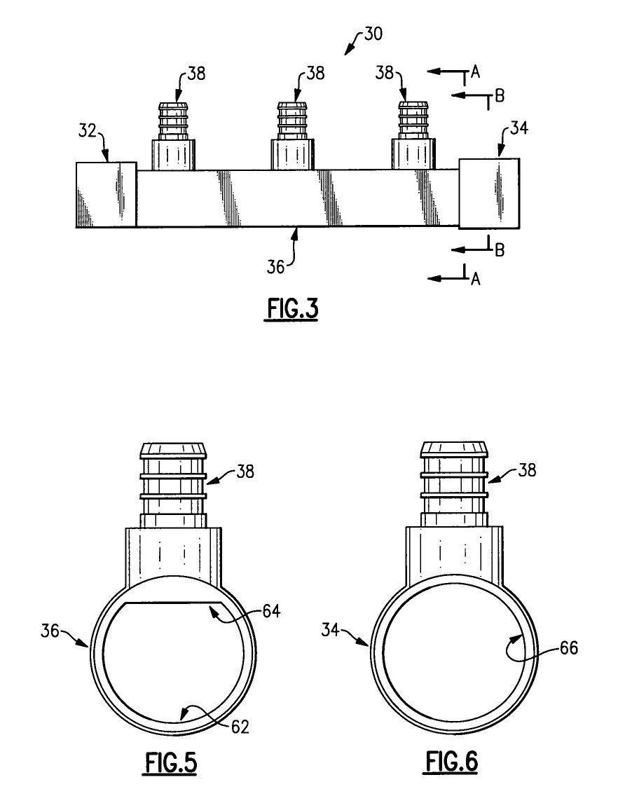

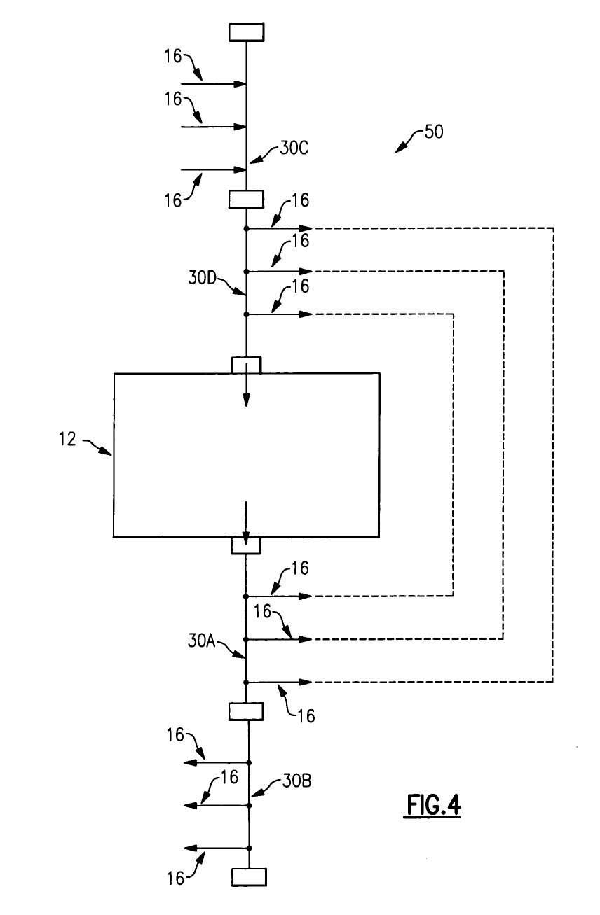

The male end 32 and the female end 34 are pre-formed on the modular manifold assembly 30. The male end 32 and the female end 34 are flared to have a circular cross-section as shown in FIG. 6, which facilitates joining multiple modular manifold assemblies 30, a termination and/or attachment to a main fluid distribution system as illustrated in FIG. 4. The male end 32 and the female end 34 are designed complementary to each other, i.e. a diameter associated with the circular cross-section of the male end 32 is smaller than a diameter associated with the female end 34. The male end 32 and the female end 34 of each modular manifold assembly 30 are preferably flared to conform to ANSI B16.22 for wrought copper and bronze solder-joint drainage fittings.

Standard branch connectors (not shown), which include but are not limited to a standard “T” and a 90° elbow, are easily assembled to the modular manifold assemblies 30 by localized brazing within the circular openings of the male end 32 and the female end 34. Sweat soldering or brazing is also employed to assemble the various components together to form the desired fluid system configuration for standard baseboard heating or, alternatively, PEX, that is, cross-linked polyethylene fittings, may be employed to accommodate PEX systems.

FIG. 4 shows an example fluid distribution system 50 including four modular manifold assemblies 30A-30D attached to a main fluid distribution system 12. Modular manifold assemblies 30A and 30B are supply manifolds, which supply a fluid to the fluid distribution system 50. The fluid travels through the distribution tubes 16 into modular manifold assemblies 30C and 30D, which are return manifolds. The fluid is consolidated within the return manifolds 30C and 30D and returned to the main fluid distribution system 12. Supply manifold 30A is connected to supply manifold 30B such that the distribution tubes 16 that extend from supply manifold 30A extend in a direction opposite that of the distribution tubes 16 extending from supply manifold 30B. This allows the main fluid distribution system 12 to be centralized to accommodate fluid distribution to areas in opposite directions from the main fluid distribution system 12.

FIG. 5 shows a cross-section of one embodiment of a modular manifold assembly 30 of the present invention through a Section A-A shown in FIG. 3. Section A-A is drawn through a body 26 which includes a D-shaped cross-section that has a first portion 62 that is substantially circular and a second portion 64 that is substantially linear. A distribution connector 38 is disposed on the body 36. The distribution connector 38 includes a barbed-end for connection to a distribution tube 16, as previously shown in FIG. 4.

FIG. 6 shows a cross-section of one embodiment of a modular manifold assembly 30 of the present invention through Section B-B shown in FIG. 3. Section B-B is drawn through a female end 34, which includes a substantially circular cross-section 66. A distribution connector 38 is disposed on the body 36 (not shown).

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A modular manifold system for a fluid distribution system comprising:
at least two modules, wherein each module includes a manifold having:
a first end;
a second end; and
a body disposed between said first end and said second end, wherein said body includes at least one distribution connection.

2. The modular manifold system of claim 1, wherein one of said first end and said second end includes a female connection and the other of said first end and said second end includes a male connection.

3. The modular manifold system of claim 2, wherein said female connection and said male connection each include flared portions.

4. The modular manifold system of claim 1, wherein said body comprises a D-shaped cross-section.

5. The modular manifold system of claim 4, wherein said D-shaped cross-section comprises a first portion that is substantially curved and a second portion that is substantially linear.

6. The modular manifold system of claim 1, wherein said at least one distribution connection comprises at least one barbed end.

7. A method of creating a fluid distribution system to accommodate individual system requirements comprising the steps of:
a) determining a first desired configuration of fluid distribution,
b) selecting a plurality of modular manifolds based upon the first desired configuration;
c) assembling the plurality of modular manifolds to one another to achieve the first desired configuration; and
d) connecting the assembled plurality of modular manifolds to a main distribution system.

8. The method of claim 7, wherein step b) comprises determining what additional standard components are required to achieve the first desired configuration.

9. The method of claim 8, wherein step c) comprises assembling the additional standard components to the plurality of modular manifolds to achieve the first desired configuration.

10. The method of claim 7, wherein step c) comprises assembling a female end of at least one of the plurality of modular manifolds to a male end of at least another of the plurality of modular manifolds.

11. The method of claim 7, wherein step c) comprises assembling at least one of the plurality of modular manifolds to a termination.

12. The method of claim 7, wherein step c) comprises assembling the plurality of modular manifolds using sweat soldering.

13. The method of claim 7, wherein step d) comprises connecting at least one distribution connection of at least one of the plurality of modular manifolds to a tube for distribution.

14. The method of claim 13, further including the step of forming a barbed end on the at least one distribution connection for gripping engagement with the tube.

15. The method of claim 7, further including the step of determining a second desired configuration different from the first desired configuration and repeating steps b) through d).

16. The method of claim 7, further including the step of forming a body of at least one of the plurality of modular manifolds, wherein the body includes a D-shaped cross-section.

17. The method of claim 16, further including forming the D-shaped cross-section, wherein the step of forming the D-shaped cross-section includes forming a first portion that is substantially curved and forming a second portion that is substantially linear.
